(19) United States
(12) Patent Application Publication
(10) Pub. No.: US 2015/0201587 A1
(43) Pub. Date: Jul. 23, 2015

(54) COW RETRIEVAL SYSTEM

(71) Applicant: SCR ENGINEERS LTD, Netanya (IL)

(72) Inventors: Eyal Brayer, Kfar Monash (IL); Yariv Avisar, Ein Sarid (IL); Tzvi Shterenberg, Shadmot Mehola (IL); Oded Satat, Ramat Zvi (IL)

(21) Appl. No.: 14/418,634

(22) PCT Filed: Aug. 18, 2013
(86) PCT No.: PCT/IL13/50700

§ 371 Date: Jan. 30, 2015

Related U.S. Application Data
(60) Provisional application No. 61/684,704, filed on Aug. 18, 2012.

(51) Int. Cl. A01K 29/00; A01K 11/00

(52) U.S. Cl. CPC A01K 29/00; A01K 11/006

(57) ABSTRACT

A cow retrieval system including one or more elevated rails and one or more trolleys translational along the rail and carrying at least one cow stimulating device operative to stimulate a cow to walk towards a desired location. The cow retrieval system could also include a cow tag localization system so to be operative to localize a tag attached to a cow, identify and retrieve the cow based on information input from the localization system.

### TECHNICAL FIELD

The current method and apparatus relate to systems for retrieving herd animals and in particular to automatic systems for retrieving cows.

### BACKGROUND

Dairy cow farmer's livelihood depends on the milk produced by their dairy cows. A dairy cow is commonly milked twice to four times a day. Most cows enter the milking parlor at milking time at their own will. However, some cows tend to remain in their places, commonly recumbent and reluctant to get up and do not enter the milking parlor at their own will at which time the farmer must approach each individual cow and drive the cow towards and into the milking parlor.

This activity consumes much effort and time and some farmers commonly refrain from actively retrieving such cows which results in the cow missing the round of milking. Over time, the cumulative effect of cows missing rounds of milking is expressed in a reduction in the overall dairy farm milk production and loss of income.

Existing automatic herd control systems manipulate (open and close) gates guiding walking cows into a desired location (e.g., milking stalls) and various functions such as washing cow's udders, preventing mounting or body elevation and driving cows out of a stall. However, currently, a solution for automatically retrieving reluctant dairy cows is not yet available on the market.

### SUMMARY

The current system and method seeks to provide a system for automatically retrieving herd animals and in particular cows, minimizing the phenomenon of cows skipping their milking time slot and maximizing milk production over time.

The current system and method seeks to provide a system for automatically retrieving herd animals and in particular cows, that adds to the hands-off operation of a dairy farm, allowing a dairy farmer to utilize his or her time in a more efficient manner.

There is thus provided in accordance with an example a cow retrieval system including one or more elevated rails placed at a height unreachable by a cow and one or more trolleys translational along the rail and carrying one or more cow stimulating devices operative to stimulate a cow to walk towards a desired location.

In accordance with another example, the cow stimulating device is one or more devices selected from a group of devices including a speaker, a low voltage electrical conducting wire, an air gun, a rotating bullwhip, a water gun, a soft ball on a tether and a cow driving fence.

In accordance with yet another example, the trolley also includes one or more carrier arms, one or more air compressors and one or more cow or tag identification verification devices selected from a group of devices consisting of an RFID reader, a camera, a barcode reader and an optical sensor.

In accordance with still another example, the system is operative to receive a current location of a cow, receive a destination location for the cow and automatically drive the cow from the current location to the destination location.

In accordance with another example, the system also includes one or more transmitters/receivers operative to receive information from and transmit information to a remote computer having a display. The remote computer is at least one of a group consisting or a personal desktop computer, a portable computer such as a laptop computer, a tablet computer and a cellular telephone.

In accordance with yet another example, there is also provided a cow and/or tag localization system so that a cow is localized, identified and retrieved by the cow retrieval system based on information input from the localization system

In accordance with still another example, the system is also operative to receive data regarding a location of cow or a tag attached to the cow, drive the trolley to the location of the cow, verify tag or cow information and activate the cow stimulation device to stimulate and urge the cow to walk towards a desired location.

In accordance with another example, the trolley also carries an arm and a latch reversibly engageable with a latch receiving mechanism attached to a collar of a cow. The latch and latch receiving mechanism are operative to detach from each other should the cow begin to resist and develop aberrant behavior so that to prevent any injury to cow.

In accordance with yet another example, the remote computer is operative to generate an alert to a user and/or activate the cow retrieval system functionality when one or more of the following circumstances apply:

Identifying a cow missing from the milking parlor at a dedicated time slot;

Identifying cows statistically late or missing from the milking parlor; and

Applying a daily milking schedule of the dairy farm resident cows.

In accordance with still another example, there is also provided a method for automatically retrieving a cow, including receiving data regarding a tag or a cow information and location, driving a trolley carrying at least one cow stimulating device along an elevated rail to the location of the cow, verifying the tag and/or cow information, activating the cow stimulating device and stimulating and urging the cow to walk towards a desired location.

### BRIEF DESCRIPTION OF THE DRAWINGS

The present method and apparatus will be understood and appreciated more fully from the following detailed description, taken in conjunction with the drawings in which:

FIG. 1 is a simplified illustration of an automatic cow retrieval system as viewed from above in accordance with an example;

FIG. 2 is a simplified illustration of an automatic cow retrieval system as viewed from above in accordance with another example;

FIG. 3 is a simplified diagram of a trolley in accordance with an example;

FIGS. 4A, 4B, 4, 4D, 4E, 4F and 4G are elevated side-view simplified illustrations of cow stimulating devices in accordance with several examples;

FIGS. 5A and 5B are side view simplified illustrations of a carrier arm in accordance with an example;

FIGS. 6A, 6B and 6C are simplified illustrations of a trolley and stimulating device in accordance with three examples;

FIGS. 7A, 7B, 7C and 7D are simplified illustrations of a trolley and stimulating device in accordance with other examples;

FIG. 8 is a block diagram of automatic retrieval of a cow by automatic cow retrieval system in accordance with an example;

FIG. 9 is a flowchart of alert generation and activation of automatic cow retrieval system in accordance with an example; and

FIGS. 10A and 10B are simplified illustrations of displays of a system computer in accordance with two examples.

### DETAILED DESCRIPTION

Referring now to FIG. 1, which is a simplified illustration of an automatic cow retrieval system 100 as viewed from above in accordance with an example. In FIG. 1 the roof has been removed for the purpose of illustration and to reveal retrieval system 100. A typical dairy farm cow shed 102 commonly includes one or more fenced-in lots 104 separated by a driveway 106. A shed 102 commonly also includes support poles 108 supporting the roof (not shown). Cows 110 are free to move within lots 104. System 100 could comprise one or more elevated rails 112 suspended from the roof (not shown) or suspended from or attached to support poles 108 or from dedicated poles (not shown).

The term “Rail” in the context of the present disclosure means any construction operative to allow bi-directional translation of a trolley therealong, placed at a height unreachable by a cow, e.g., a rod, a cable, a rope, etc. The shed commonly is adjacent and abutting a milking parlor, or alternatively, the shed includes a gateway and a chute or pathway leading to a milking parlor, a truck or any other location. One or more Trolleys 114 could be translational along rail 112 as indicated by an arrow designated reference numeral 150 and/or be translational across a bridge 116 between at least two rails, as indicated by an arrow designated reference numeral 170, bridge 116 itself being translational along rail 112 as indicated by an arrow designated reference numeral 150.

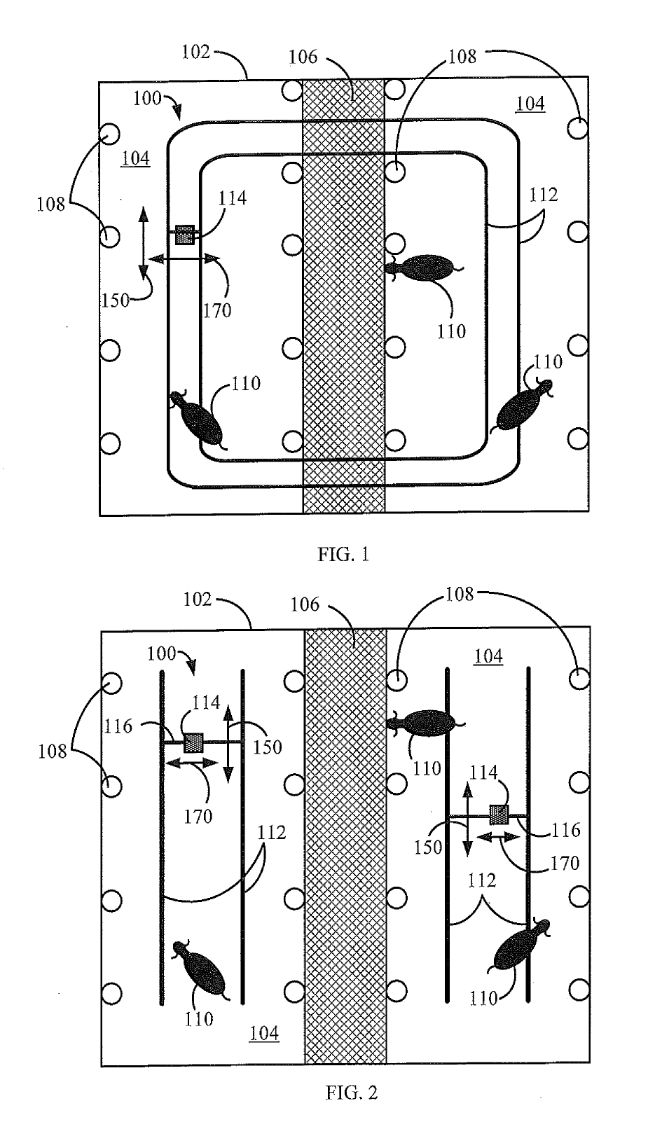

As shown in FIG. 2, which is a simplified illustration of an automatic cow retrieval system 100 as viewed from above in accordance with another example, System 100 could comprise one or more pairs of rails 112 suspended from the roof (not shown) or suspended from or attached to support poles 108. As in FIG. 1, one or more Trolleys 114 could be translational along rails 112 and/or translational across bridge 116 between at least two rails, which itself could be movable along rails 112 as indicated by corresponding arrows designated reference numerals 170 and 150.

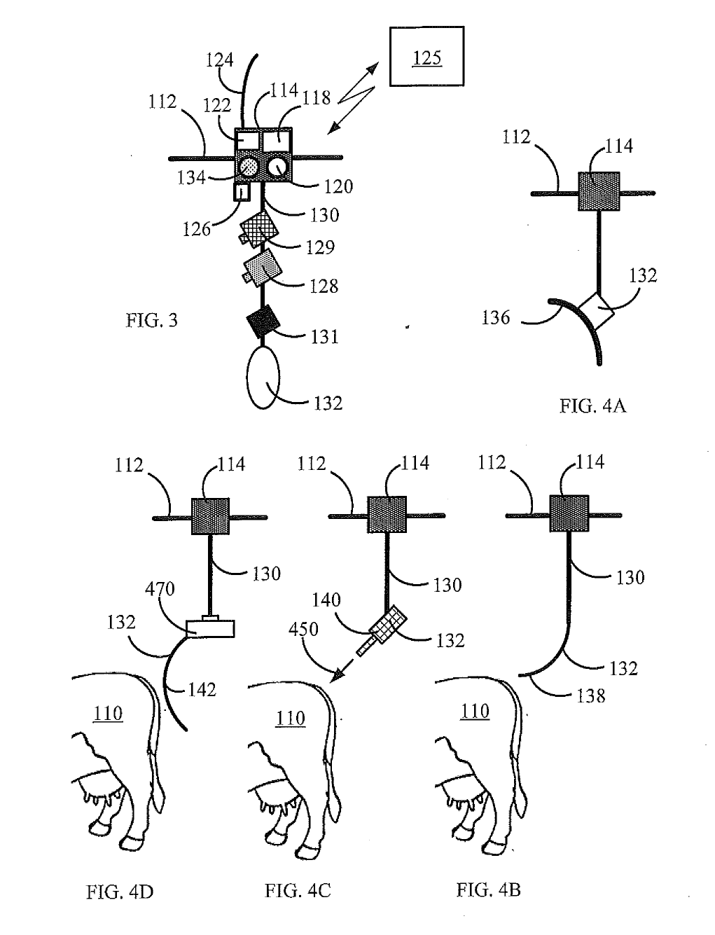

Reference is now made to FIG. 3, which is a simplified diagram of a trolley 114 in accordance with an example. Trolley 114 could carry a carrier arm 130 carrying a cow stimulating device 132 and include one or more controllers 118 operative to activate a motor 120 propelling trolley 114 along rails 112. Additionally and optionally, trolley 114 could also include an air compressor 134. Alternatively and optionally, compressed air could be supplied from a central compressor.

Additionally, trolley 114 could also include a transmitter/receiver 122 and an antenna 124 to receive information from and transmit information to a remote computer 125 as will be described in greater detail below. Remote computer 125 could be a personal desktop computer, a portable computer such as a laptop computer, a tablet computer and a cellular telephone.

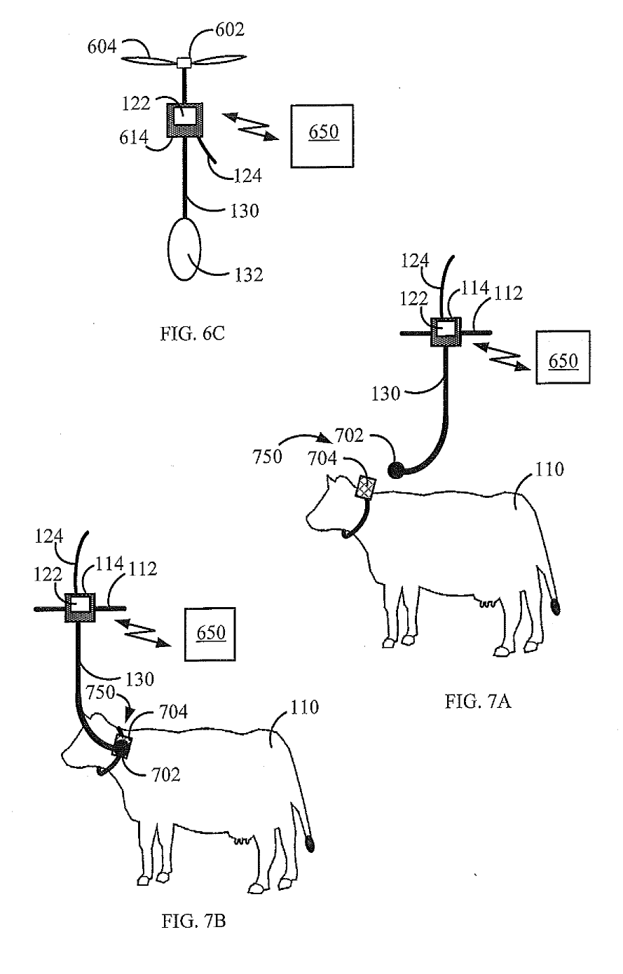

Additionally and optionally, trolley 114 could also include tag 650 (FIG. 6B)/cow 110 identification verification devices such as an RFID reader 126 operative to read an RFID in tag 650 (FIG. 6B) or an RFID tag attached to cow 110, a camera 128, a barcode reader 129 and an optic sensor 131.

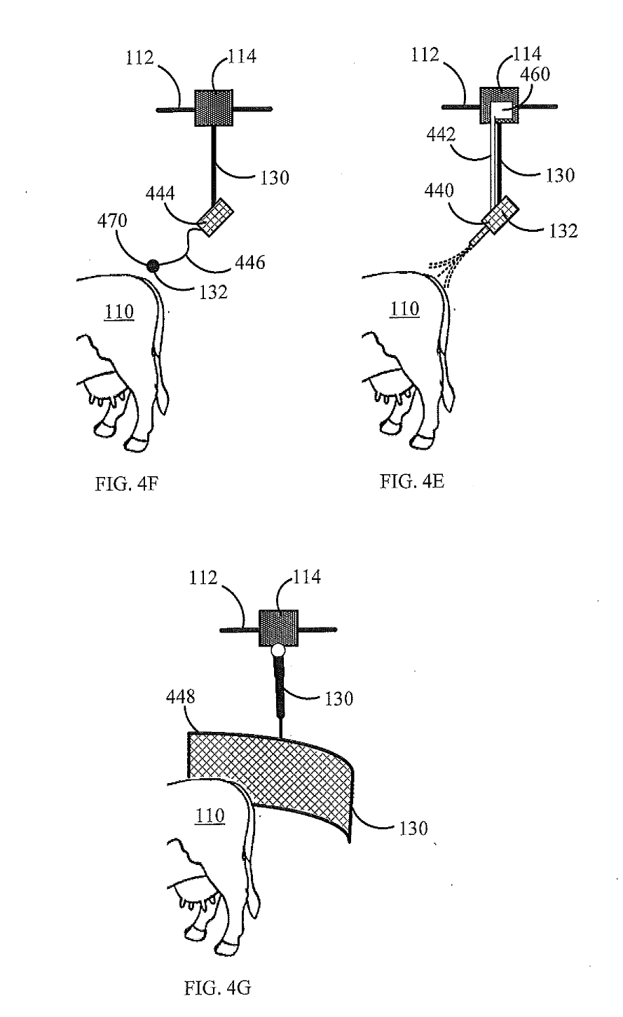

Referring now to FIGS. 4A, 4B, 4C, 4D, 4E, 4F and 4G, which are elevated side-view simplified illustrations of cow stimulating devices 132 in accordance with several examples. Cow stimulating devices 132 shown in FIGS. 4A-D are designed to stimulate and urge a cow 110 (FIGS. 1 and 2) to get up (when recumbent) and/or walk towards a desired location. In the following examples, a milking parlor is described as the desired location. However, such a location should not be read as limited to a milking parlor and could be understood as any location to which a farmer would commonly move a cow such as a milking parlor, a chute, a gate or any other similar location.

Optionally, trolley 114 of system 100 is operative to follow a cow 110 not heading in the direction of the milking parlor employing identification verification devices as described above and further stimulate cow 110 to head in the correct direction employing stimulation devices 132. As shown in FIG. 4A, a cow stimulation device 132 could include a speaker 136 generating sounds known to be disturbing to a cow.

Another example of a cow stimulation device 132 depicted in FIG. 4B could be a low voltage electrical conducting wire 138 generating a low non-painful voltage upon contact with the cow sufficient to initiate getting up (when recumbent) and/or walking towards the milking parlor. A third example of a cow stimulation device 132 illustrated in FIG. 4C could be an air gun 140 operative to blow a stream of compressed air indicated by an arrow designated reference numeral 450. As shown in FIG. 4D, cow stimulation device 132 could also include a rotating bullwhip 142 attached to a horizontally rotating motor 470 so that when motor 470 slowly rotates, bullwhip 142 could gently whip a cow 110 recumbent or standing in close propinquity thereto.

FIG. 4E depicts a solution similar to that shown in FIG. 4C, however air gun 140 could be replaced with a water gun 440 supplied from a water reservoir 460 via a water conduit 442. Water reservoir 460 could be refilled when trolly 114 arrives at a docking station (not shown).

As shown in FIG. 4F, stimulating device 132 could be a soft ball 470 attached to a tether 446 and propelled in a direction of a cow 110 from a propulsion ball gun 444. Tether 446 of soft ball 470 could be pulled back into gun 444 to enable ball 470 to be reused as necessary.

Alternatively and optionally, and as seen in FIG. 4G, stimulation device 132 could also be a cow driving fence 448 that could be lowered by a telescopic arm 130 behind a cow 110. Translating trolley 114 could then drive a cow 110 in a desired direction. Cow driving fence 448 could be flat or in a form of a semi-circle as shown in FIG. 4G. Alternatively and optionally, cow driving fence 448 could form a complete circle, completely surrounding a cow 110 when lowered by telescopic arm 130 around cow 110. Driving fence 448 could be lowered so that the bottom margin thereof is at a height of approximately between 40 cm to 100 cm above ground level.

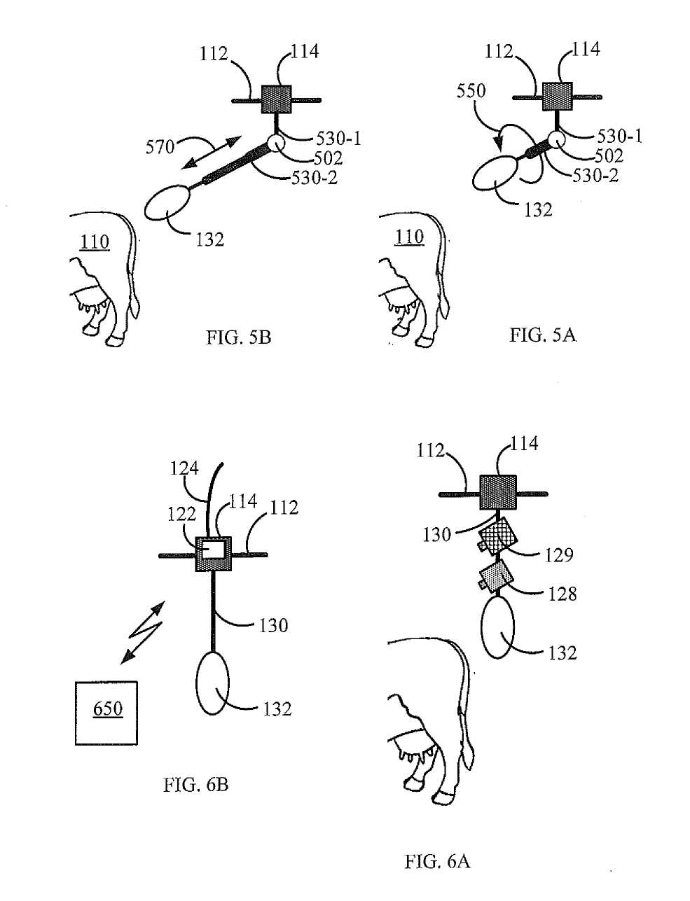

Referring now to FIGS. 5A and 5B, which are side view simplified illustrations of a carrier arm 530 in accordance with an example. Carrier arm 530 could be an articulated arm including one or more segments 530-1 and 530-2 connected to each other by a joint 502. Segments 530-1 and 530-2 could be connected to each other at a fixed angle or be rotatably moveable relative to each other as indicated by arrow designated reference numeral 550 (FIG. 5A). The movement of segment 530-2 relative to segment 530-1 could be carried out by a motor such as a servo motor (not shown) in joint 502 controlled by controller 118 (FIG. 3).

Additionally and optionally, segment 530-2 could be a telescopic arm operative to extend as shown in FIG. 5B. Additionally and optionally, one or more of segments 530-1 and 530-2 could be telescopic, extendible and retractable as indicated by arrow designated reference numeral 570. The extension and retraction of segment 530-2 could be carried out by a motor such as a servo motor (not shown) in segment 503-2 or joint 502 controlled by controller 118 (FIG. 3).

Referring now to FIGS. 6A and 6B, which are simplified illustrations of a trolley 114 and stimulating device 132 in accordance with two examples. System 100 could additionally and optionally include a cow identification verification device 602. Such a device could identify an individual cow by, for example, capturing one or images thereof and/or identify a tag 650 attached to a cow 110. As depicted in FIG. 6A, verification device 602 could be a camera 128 communicating an image of cow 110 to computer 118 in trolley 114 or, alternatively and optionally, a UPC (Universal Product Code) known as barcode reading device 129 could be operative to read a barcode placed, for example, on a cow 110 (e.g., on the cow's collar) or stamped on a tag 650 attached to the cow.

Alternatively and optionally and as illustrated in FIG. 6B, verification device 602 could be a receiver/transmitter 604 communicating with a tag 650 such as, for example, a low power consumption electronic tag such an Animal Transmit/Receive Unit (ARTU) described in Assignee's US Patent Application No. 2012/0112917.

An ARTU, described in the above reference, could be housed in a mobile tag housing, such as tag 650 (FIG. 6B), having a cover and attached to or placed inside an animal to wirelessly receive/transmit data. The ARTU can include a source of power, such as a regular or rechargeable battery or any other source of power light in weight and small enough to enable it to be carried by or inside an animal. Such an ARTU could also be lightweight, small and have an average power consumption less than 0.5 mW.

As shown in FIG. 6C, trolley 614 carrying stimulating device 132 could include hovering capabilities and be autonomous of rails 112 (FIG. 1). Trolley 614 could include an electric motor 602 driving a rotor 604 controllable by controller 118 or remotely controllable by computer 125 via antenna 124. Trolley 614 could also include a horizontal obstacle detection device (not shown) enabling trolley 614 to automatically avoid obstacles such as poles, electric wires, etc. Trolley 614 could include all above described stimulating device 132 and identification verification devices such as an RFID reader 126, a camera 128, a barcode reader 129 and an optic sensor 131.

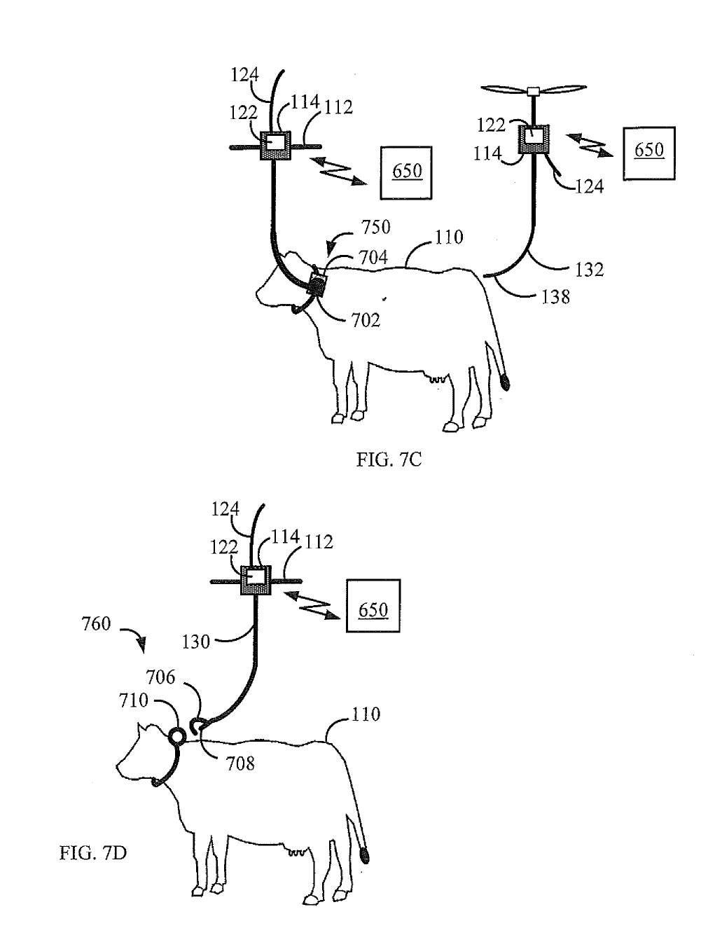

Reference is now made to FIGS. 7A, 7B, 7C and 7D, which are simplified illustrations of a trolley and stimulating device in accordance with other examples. Trolley 114 arm 130 could include a cow latching mechanism 750 including a latch 702 reversibly engageable with a latch receiver 704 attached to a collar of a cow. Latch 702 could engage with latch receiver 704 so that to tug on a cow 110 collar pulling and urging and driving cow 110 in a desired direction.

As shown in FIG. 7C, cow latching mechanism 750 could be employed together with any one of the cow 110 stimulating devices 132 described above.

As shown in FIGS. 7A and 7B, latch receiver 704 could be, for example, a magnet, whereas latch 702 could be, for example, an electromagnet controlled, for example by controller 118 in trolley 114 or remote computer 125. The magnetic attraction forces generated between latch 702 and latch receiver 704 could be designed to enable tugging on cow 110 collar but operative to detach from each other should cow 110 begin to resist and develop aberrant behavior so that to prevent any injury to cow 110.

FIG. 7D illustrates another example of a cow latching mechanism 760. As shown in FIG. 7D, latch 706 could be a hook closed with a bias-controlled or electrically controlled tongue 708. Optionally, tongue 708 could be controlled by controller 118 or by computer 125. Latch receiver 710 could be a ring attached to cow 110 collar.

Cow latching mechanism 760 could be designed to enable tugging on cow 110 collar but operative to allow latch 706 and latch receiver 710 to detach from each other should cow 110 begin to resist and develop aberrant behavior so that to prevent any injury to cow 110. Optionally, latch receiver 710 could be designed to tear when stressed by forces greater than normal such as when cow 110 resist and develop aberrant behavior so that to prevent any injury to cow 110.

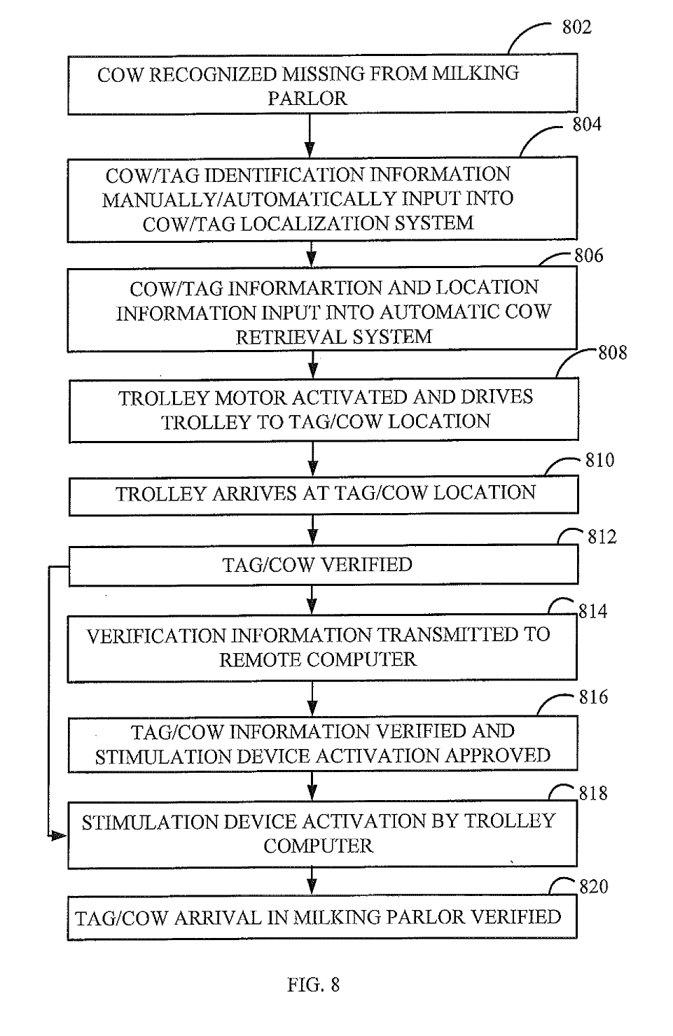

Reference is now made to FIG. 8, which is a block diagram of automatic retrieval of a cow by automatic cow retrieval system 100 in accordance with an example. Automatic cow retrieval system 100 could communicate with a cow 110 localization system, such as a system employing optical devices for cow localization (such as, for example, one or more cameras or one or more optical sensors operative to read an optical signal emitted, for example, from an LED light on the Tag 650) and identification and/or tag 650 localization system such as that described in Assignee's US Patent Application No. 2012/0112917 operative to communicate with and localize a tag 650 attached to a cow 110 so that a cow 110 could be localized, identified and retrieved based on information input from the localization system.

System 100 could be operative to receive a current location of a cow 110 (e.g., geographical coordinates or location on a predetermined map grid), receive a destination location for cow 110 (e.g., geographical coordinates or location on a predetermined map grid) and automatically drive cow 110 from the current location to the destination location.

In one example, when a cow 110 is recognized to be missing from the milking parlor (block 802) either automatically or by the dairy farmer, cow 110 identification data, such as barcode number or tag 650 identification information could be manually or automatically input into such a cow tag localization system (block 804), which in turn localizes tag 650 or cow 110 (block 806).

Data regarding tag 650 identifying cow 110 location is manually or automatically input into system 100 (block 806) computer 118 or, alternatively, transmitted to computer 118 from remote computer 125 via transmitter/receiver 122, which activates trolley 114 motor 120 propelling trolley 114 along elevated rails 112 driving trolley 114 carrying a carrier arm 130 and a cow stimulating device 132 to the location of cow 110 (block 808). Cow 110 identification could be carried out, for example, by capturing and communicating, for example, to remote computer 125, one or more images thereof, reading a barcode attached to cow 110, receiving an optical signal, for example, from an LED on tag 650 and/or identifying tag 650 attached to a cow 110, and communicating tag 650 information to remote computer 125.

Upon arrival at the tag 650/cow 110 location (block 810), cow 110 could be optically verified, tag 650 information could be verified (block 812) by RFID reader 126 or by communication between tag 650 and computer 118 via transmitter/receiver 122, which in turn could communicate the verification information to remote computer 125 (block 814). Alternatively and optionally, camera 128 (FIGS. 3 and 6A) could communicate an image of cow 110 to computer 118 in trolley 114 or, alternatively and optionally, barcode reading device 129 (FIGS. 3 and 6A) could read and communicate to computer 118 a barcode stamped on a tag 650 or be attached to the cow.

Once tag 650 and/or cow 110 identification is verified as described above, computer 118 could independently, or upon automatic or manual authorization (block 816) from remote computer 125 activate cow stimulation device 132 (block 818) to stimulate and urge cow 110 (FIGS. 1 and 2) and, optionally, adjacent cows 110 to get up (when recumbent) and/or walk towards the milking parlor. Once cow 110 arrives in the milking parlor, a verification signal could be communicated to the cow 110 and/or tag 650 localization system (block 820).

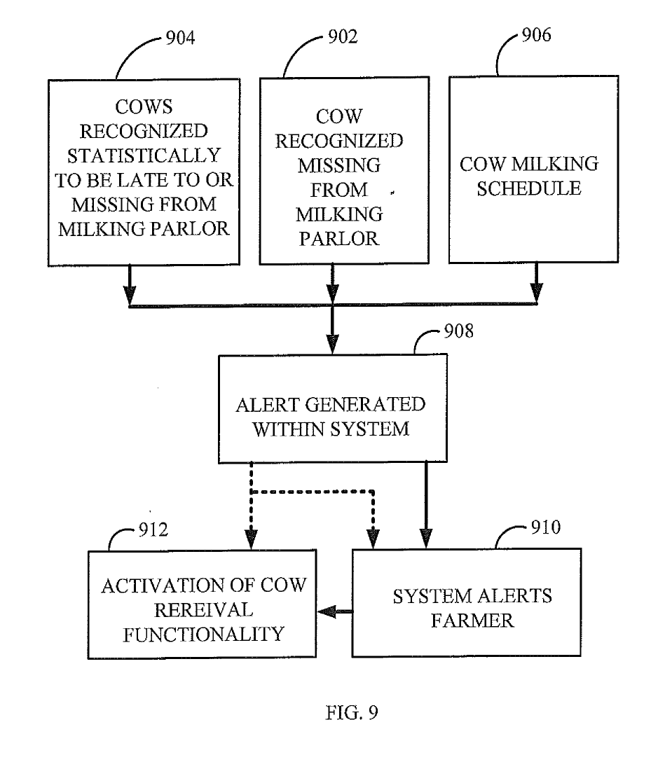

Referring now to FIG. 9, which is a flowchart of alert generation and activation of automatic cow retrieval system 100 in accordance with an example. A system 100 remote computer 125 memory could generate an alert in several circumstances. One circumstance could be a cow 110 identified missing from the milking parlor at a dedicated time slot dedicated to milking the specific cow (block 902).

A second circumstance could be cows statistically late or missing (i.e., skipping milking time slots) from milking parlor (block 904). System 100 computer 125 could collect data over a period of time regarding cows 110 arrival and milking at milking parlor and generate statistical information regarding cows regularly tardy or missing from the milking parlor. In a manually run dairy farm, farmers, for various reasons, often opt to allow these cows to skip their milking time slot, which cumulatively results in reduced milk production over time. This functionality of system 100 prevents loss of milk production by automatically alerting the farmer and/or system 100 itself to retrieve obstinate cows.

A third circumstance could be a daily milking schedule of the dairy farm resident cows 110, input manually or automatically into system 100 (block 906). System 100 could identify and pair each cow 110 and its specific milking time slot and retrieve each cow 110 when its corresponding milking time slot approaches.

Any one or combination of the above circumstances (blocks 902, 904 and 906) could generate a system alert (block 908). The system alert could be directly communicated to the farmer (block 910) who, in turn, manually activates the cow retrieval functionality (block 912). Alternatively and optionally, a generated system alert (block 908) could automatically activate the cow retrieval functionality (block 912) and, optionally concurrently alert the farmer (block 910) as depicted in FIG. 9 with broken-line arrows.

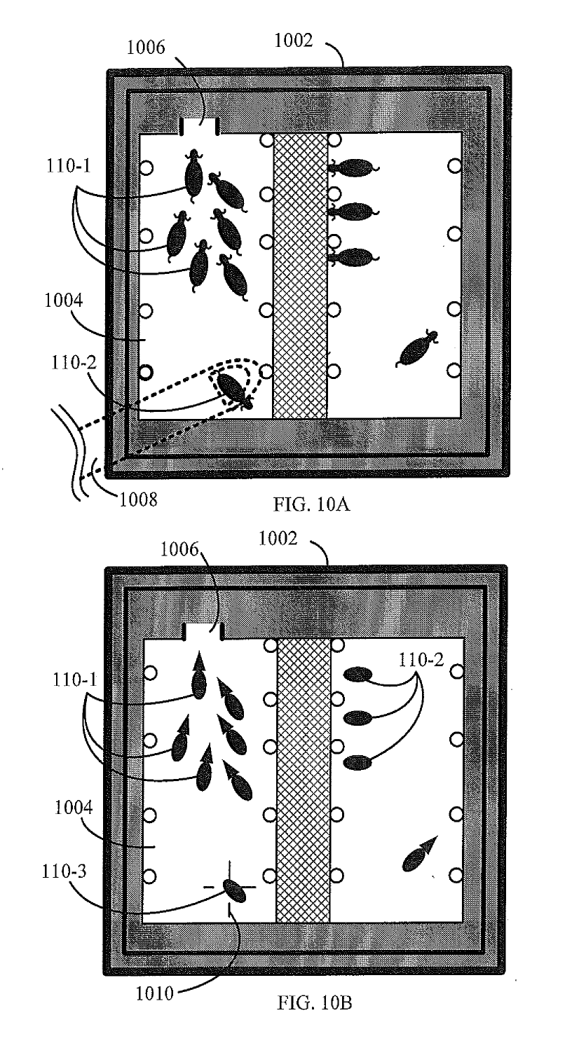

Reference is now made to FIGS. 10A and 10B, which are simplified illustrations of a display 1002 of system 100 computer 125 in accordance with an example. Display 1002 could be a touch-screen and display a real time image 1004 of cows 110 in the cowshed, for example, as captured from a camera located at the ceiling of the cowshed. A user could identify a group of cows such as cows 110-1, facing an open gate 1006 (e.g., leading to a milking parlor) and an isolated cow 110-2 not facing the gate. A user may press on the image of cow 110-2 with a finger 1008, depicted in FIG. 10A by broken lines, which could automatically activate system 100 retrieval functionality to retrieve selected cow 110-2.

In another example, shown in FIG. 10B, system 100 computer 125 could generate a graphic display of cows 110 in the cowshed. In the display in FIG. 2, moving cows 110-1 are depicted by having arrow heads also indicating the direction of movement, whereas stationary cows 110-2 and cow 110-3 lack an arrow head. A user may identify and mark a stationary cow such as cow 110-3 with, for example, cross-hairs 1010, employing a finger (e.g., on a touch screen) or by using keyboard arrows, a mouse or a joystick, which could automatically activate system 100 retrieval functionality to retrieve selected cow 110-2.

It will also be appreciated by persons skilled in the art that the present method and apparatus are not limited to what has been particularly shown and described hereinabove. Rather, the scope of the method and apparatus includes both combinations and sub-combinations of various features described hereinabove as well as modifications and variations thereof which would occur to a person skilled in the art upon reading the foregoing description and which are not in the prior art.

What we claim is:

1. A cow retrieval system comprising:
At least one elevated rail placed at a height unreachable by a cow; and
At least one trolley translational at least along the rail and carrying at least one cow stimulating device operative to stimulate a cow to walk towards a desired location.

2. The system according to claim 1, wherein the trolley also includes
At least one motor propelling the trolley along the rail;
At least one controller operative to activate the motor; and
At least one transmitter/receiver operative to receive information from and transmit information to a remote computer.

3. The system according to claim 2, wherein the remote computer is at least one of a group consisting or a personal desktop computer or a portable computer including a laptop computer, a tablet computer and a cellular telephone.

4. The system according to claim 1, wherein the cow stimulating device is at least one of a group consisting of a speaker, a low voltage electrical conducting wire, an air gun, a rotating bullwhip, a water gun, a soft ball on a tether and a cow driving fence.

5. The system according to claim 1, wherein the trolley also comprises at least one carrier arm, at least one air compressor and at least one tag or cow identification verification device selected from a group of devices consisting of an RFID reader, a camera, a barcode reader and an optical sensor.

6. The system according to claim 5, wherein the carrier arm is an articulated arm including at least two segments connected to each other by a joint.

7. The system according to claim 6, wherein the carrier arm segments are connected to each other at a fixed angle or are rotatably moveable relative to each other.

8. The system according to claim 6, wherein at least one carrier arm segment is a telescopic arm segment.

9. The system according to claim 1, wherein the system also includes a cow and/or tag localization system so that a cow is localized, identified and retrieved based on information input from the localization system.

10. The system according to claim 1, wherein the system is operative to:
Receive data regarding a location of cow or a tag attached to the cow;
Drive the trolley to the location of the cow;
Verify tag or cow information; and
Activate the cow stimulation device to stimulate and urge the cow to walk towards a desired location.

11. The system according to claim 10, wherein the tag or cow information verification is carried out employing at least one of a group consisting of a RFID reader, a computer communicating with the tag, a camera communicating an image of the cow to a computer and a barcode reading device.

12. The system according to claim 1, wherein the system is operative to:
Receive a current location of a cow;
Receive a destination location for the cow; and
Automatically drive the cow from the current location to the destination location.

13. The system according to claim 1, wherein the trolley is also translational across a bridge between two or more elevated rails, the bridge being translational along the rails.

14. The system according to claim 1, wherein the desired location is at least one of a milking parlor, a gateway, a chute, a pathway and a truck.

15. The system according to claim 1, wherein the trolley has hovering capabilities and is autonomous of the rails.

16. The system according to claim 1, wherein the system also includes a cow latching mechanism including a latch reversibly engageable with a latch receiver attached to a collar of a cow.

17. The system according to claim 16, wherein the latch receiving mechanism is a magnet and the latch is an electromagnet.

18. The system according to claim 16, wherein the latch receiving mechanism is a be a ring attached to a cow collar and the latch is hook closed with a bias-controlled tongue.

19. The system according to claim 16, wherein the latch and latch receiving mechanism are operative to detach from each other should the cow begin to resist and develop aberrant behavior so that to prevent any injury to cow.

20. The system according to claim 2, wherein the remote computer is operative to at least one of generate an alert to a user and activate the cow retrieval system functionality.

21. The system according to claim 20, wherein the computer generates an alert or activates system functionality in at least one circumstance including:
A cow is identified missing from the milking parlor at a dedicated time slot;
Cows statistically late or missing from the milking parlor; and
A daily milking schedule of the dairy farm resident cows.

22. The system according to claim 2, wherein the remote computer also includes a display.

23. The system according to claim 22, wherein the display is a touch-screen and displays a real time image of cows in the cowshed.

24. The system according to claim 22, wherein a user presses on an image of a cow with a finger to automatically activate the system retrieval functionality to retrieve the selected cow.

25. The system according to claim 22, wherein the remote computer is operative to generate a graphic display of cows in the cowshed.

26. The system according to claim 22, wherein a user identifies and marks a stationary cow by employing at least one of a finger, a keyboard, a mouse and a joystick to automatically activate the system retrieval functionality to retrieve the selected cow.

27. The system according to claim 1, wherein the trolley also includes a water reservoir.

28. The system according to claim 4, wherein the cow driving fence is flat, in a form of a semi-circle or forms a complete circle, completely surrounding a cow when lowered around cow.

29. A method for automatically retrieving a cow, comprising:
Receiving data regarding a tag or a cow information and location;
Driving a trolley carrying at least one cow stimulating device along an elevated rail to the location of the cow;
Verifying the tag and/or cow information;
Activating the cow stimulating device; and stimulating and urging the cow to walk towards a desired location.

30. A method for automatically retrieving a cow, comprising:
Receiving a current location of a cow;
Receiving a destination location for the cow; and
Automatically driving the cow from the current location to the destination location.

31. A method for automatically retrieving a cow, comprising:
Generating an alert to a user and/or activating the cow retrieval system functionality when at least one of the following circumstances apply:
Identifying a cow missing from the milking parlor at a dedicated time slot;
identifying cows statistically late or missing from the milking parlor; and
applying a daily milking schedule of the dairy farm resident cows.

32. A system for localizing and retrieving a cow, comprising:
a tag localization system operative to communicate location of a cow to which the tag is attached; and
a cow retrieval system including
at least one elevated rail; and
at least one trolley translational along the rail
and carrying at least one cow stimulating device and operative to localize, identify and retrieve a cow based on information input from the localization system.
